(19) United States
(12) Patent Application Publication
(10) Pub. No.: US 2014/0163808 A1
(43) Pub. Date: Jun. 12, 2014

(54) SYSTEM AND METHOD OF ACQUIRING BIAS OF YAW RATE SENSOR FOR VEHICLE

(71) Applicant: HYUNDAI MOTOR COMPANY, Seoul (KR)

(72) Inventors: Hai Jin Seo, Yongin (KR); Jong Il Yu, Seongnam (KR)

(73) Assignee: HYUNDAI MOTOR COMPANY, Seoul (KR)

(21) Appl. No.: 13/829,077

(22) Filed: Mar. 14, 2013

(30) Foreign Application Priority Data
Dec. 7, 2012 (KR) 10-2012-0142057

(51) Int. Cl. G06F 17/00

(52) U.S. Cl. CPC G06F 17/00
USPC 701/31.1

(57) ABSTRACT

Disclosed herein is a system and method of acquiring the bias of a yaw rate sensor for a vehicle. The method includes matching, by a processor, map information based on global positioning system (GPS) information and vehicle speed information and determining a curvature of a road. The method further includes calculating, by the processor, a map based yaw degree based on the curvature of the road using steering angle information and the vehicle speed information. Additionally, the method includes acquiring, by the processor, the bias of the yaw rate sensor by comparing a measured value of the yaw rate sensor with the map based yaw degree.

### CROSS-REFERENCE TO RELATED APPLICATION

This application claims under 35 U.S.C. §119(a) the benefit of Korean Patent Application No. 10-2012-0142057 filed on Dec. 7, 2012 the entire contents of which are incorporated herein by reference.

### BACKGROUND OF THE INVENTION

1. Field of the Invention

The present invention relates to a system and method of acquiring the bias of a yaw rate sensor for a vehicle capable of accurately detecting the bias of the yaw rate sensor while driving on a curved or bumpy road, thereby reducing computation error of a vehicle yaw degree.

2. Description of the Related Art

Although the yaw degree of a vehicle has been computed using a global positioning system (GPS), real time computation has not been able to be computed using GPS because the yaw degree was received once per second, thus increasing the rate erroneous operation occurring within a shadow region. Accordingly, a method of performing supplemental calculations using a yaw rate sensor has been developed.

In many conventional methods, mirco-electro-mechanical system (MEMs) sensors are used as yaw rate sensors for vehicles due to limitations in cost and size. Such MEMs gyro rate sensors have intrinsic biases due to thermal noise and the influence of the revolution of the earth, and these biases lead to errors in the acquisition of yaw degrees. In particular, since such a yaw rate bias is sensitive to a surrounding environment and is difficult to estimate, a variety of methods for estimating the yaw rate bias have been researched.

Currently commercialized vehicles adopt a yaw degree estimation algorithm using a yaw rate sensor as part of a Global Positioning System Demonstration Receiver (GPSDR). A yaw rate bias estimation method that is used to improve the accuracy of the algorithm is configured to determine whether a vehicle is running and to take the average of yaw rates when the vehicle is stationary or when the vehicle is being driven on a substantially linear road.

However, this method may not be used to estimate the yaw rate bias when a vehicle driven on a substantially curved road in which the yaw rate bias varies, thus causing potential error in the estimation of the yaw degree.

A conventional method of setting the zero reference value of a gyroscope includes a gyroscope configured to output a rotating angular speed as a voltage, a GPS receiver configured to receive GPS signals, an analog/digital converter configured to digitize the voltage output from the gyroscope, and a controller configured to detect the speed and yaw degree of a vehicle from the results of the reception of the GPS signals, determine whether the vehicle is traveling on a substantially straight road, and obtaining the gyroscope zero reference value by filtering the voltage output from the gyroscope when determined that the vehicle is traveling on a substantially straight road. However, the above described technology may not overcome the error of a yaw rate sensor.

The above description of the technologies is merely provided to help understand the background of the present invention. However, the above description of the technologies should not be construed as admitting that those technologies correspond to prior art that has been known to those having ordinary knowledge in the technical field.

### SUMMARY

Accordingly, the present invention provides a system and a method of acquiring the bias of a yaw rate sensor for a vehicle that is capable of substantially accurately detecting the bias of the yaw rate sensor even in an environment in which the yaw rate continuously varies, such as a substantially curved road, thereby computing a more accurate yaw degree.

One aspect of the present invention provides a method of acquiring a bias of a yaw rate sensor for a vehicle, including matching map information based on GPS information and vehicle speed information and determining a curvature of a road; calculating a map based yaw degree based on the curvature of the road using steering angle information and the vehicle speed information; and acquiring the bias of the yaw rate sensor by comparing a measured value of the yaw rate sensor with the map based yaw degree. The GPS information may include one or more of a location, a speed, and a yaw degree.

The acquiring process may include acquiring a map based angular speed by differentiating the map based yaw degree and acquiring the bias of the yaw rate sensor based on the difference between the map based angular speed and the measured value of the yaw rate sensor. This acquiring process may further include acquiring the bias of the yaw rate sensor by averaging the differences between the map based angular speed and the measured value of the yaw-rate sensor. Additionally, the acquiring process may include calculating a compensation value for the yaw rate sensor by removing the bias of the yaw rate sensor from the measured value of the yaw-rate sensor. The calculating process may further include acquiring a filtered compensation value for the yaw rate sensor by filtering the compensation value for the yaw rate sensor using the map based yaw degree.

The acquiring process may further include storing the bias of the yaw rate sensor at each interval. of the storing process may include acquiring a bias of the yaw rate sensor again in a substantially similar interval and comparing the acquired bias of the yaw rate sensor with the previously stored bias of the yaw rate sensor. Furthermore, the process may include determining the abnormal behavior of the vehicle or the abnormal surface of the road (e.g., a substantially uneven surface of the road) through the comparison with the stored bias of the yaw rate sensor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary block diagram illustrating a method of acquiring the bias of a yaw rate sensor for a vehicle according to an exemplary embodiment of the present invention;

FIG. 2 is an exemplary block diagram illustrating the computation of the map based yaw degree in the method of acquiring the bias of a yaw rate sensor for a vehicle shown in FIG. 1 according to an exemplary embodiment of the present invention;

FIG. 3 is an exemplary block diagram illustrating the acquisition of the bias in the method of acquiring the bias of a yaw rate sensor for a vehicle shown in FIG. 1 according to an exemplary embodiment of the present invention;

FIG. 4 is an exemplary block diagram illustrating the acquisition of a yaw degree using the method of acquiring the bias of a yaw rate sensor for a vehicle shown in FIG. 1 according to an exemplary embodiment of the present invention; and

FIG. 5 is an exemplary diagram illustrating the step of determining an abnormal behavior using the method of acquiring the bias of a yaw rate sensor for a vehicle shown in FIG. 1 according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference now will be made to the drawings, throughout which the same reference numerals are used to designate the same or similar components.

A system and method of acquiring the bias of a yaw rate sensor for a vehicle according to an exemplary embodiment of the present invention will be described with reference to the accompanying drawings.

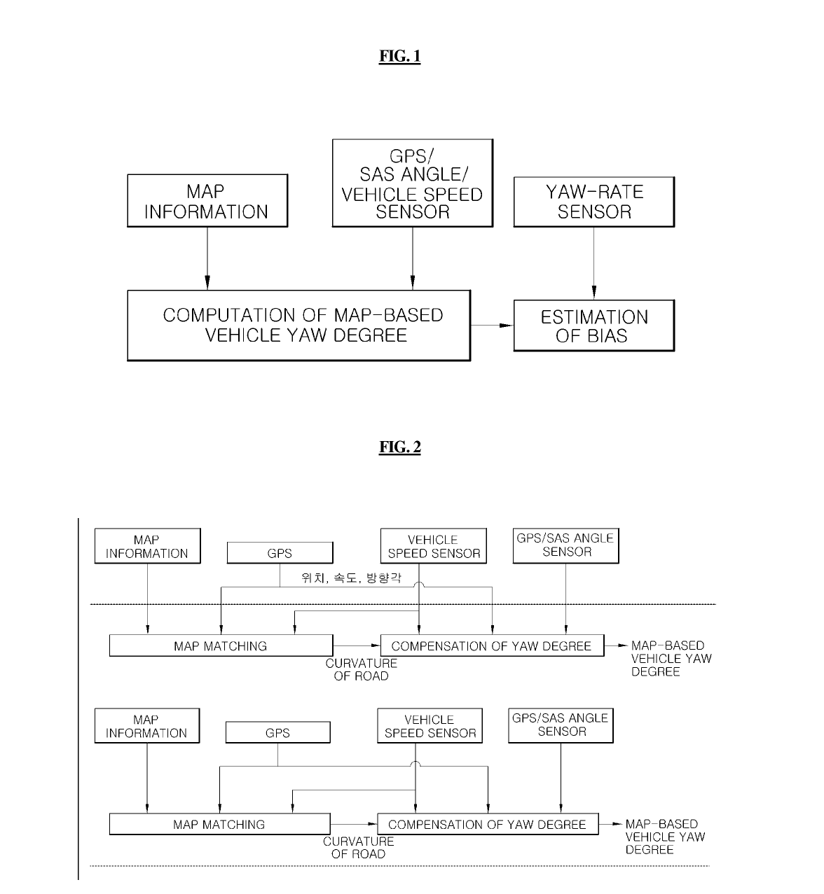

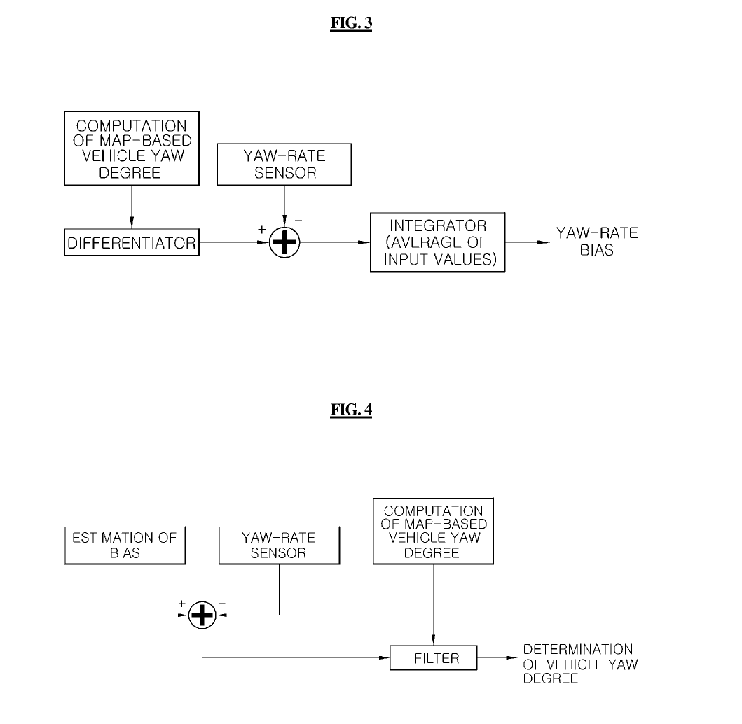

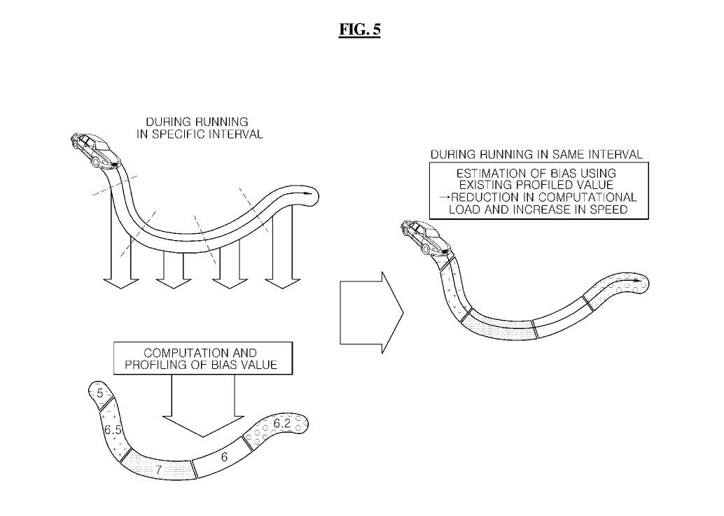

FIG. 1 is an exemplary block diagram illustrating a method of acquiring the bias of a yaw rate sensor for a vehicle, FIG. 2 is an exemplary block diagram illustrating the computation of the map based yaw degree in the method of acquiring the bias of a yaw rate sensor for a vehicle shown in FIG. 1, FIG. 3 is an exemplary block diagram illustrating the acquisition of the bias in the method of acquiring the bias of a yaw rate sensor for a vehicle shown in FIG. 1, and FIG. 4 is an exemplary block diagram illustrating the acquisition of a yaw degree using the method of acquiring the bias of a yaw rate sensor for a vehicle shown in FIG. 1.

The method of acquiring the bias of a yaw rate sensor for a vehicle according to an exemplary embodiment of the present invention includes detecting the bias of the yaw rate sensor in an environment in which the yaw rate continuously varies, such as a substantially curved road, thereby computing a more accurate yaw degree.

The method of acquiring the bias of a yaw rate sensor for a vehicle may include matching, by a processor, map information based on GPS information and vehicle speed information and determining the curvature of a road; calculating, by the processor, a map based yaw degree based on the curvature of the road using steering angle information and the vehicle speed information; and acquiring, by the processor, the bias of the yaw rate sensor by comparing the measured value of the yaw rate sensor with the map based yaw degree.

In other words, the process may include determining, by the processor, the curvature of the road based on the map information. Furthermore, the calculated accurate yaw degree of the vehicle may be calculated based on the curvature of the road using the steering angle and the like. Additionally, the yaw degree may be converted into angular speed by differentiating the yaw degree, and the bias may be estimated based on the difference between the angular speed and the measured value of the yaw rate sensor in real time.

More specifically, the, matching of the map information may be performed based on the GPS information and the vehicle speed information, and using the matched information, the curvature of the road may be determined. Additionally, the GPS information may include one or more of a location, a speed, and a yaw degree.

FIG. 2 is an exemplary block diagram illustrating the computation of the map based yaw degree in the method of acquiring the bias of a yaw rate sensor for a vehicle shown in FIG. 1. Referring to FIG. 2, the map information may be obtained, and the current vehicle location may be determined using the map information. In other words, the process may include matching, by the processor, the vehicle location into map information by substituting a location, a speed and a yaw degree, acquired using a GPS, into the map. Further, this information may include vehicle speed information, and thus the GPS information may be based on the distance the vehicle has moved within a predetermined amount of time. Through this process, information regarding the curvature of the road along which the current vehicle is moving may be calculated.

Moreover, of the process may include calculating, by the processor, the map based yaw degree based on the curvature of the road using the steering angle information and the vehicle speed information. In other words, when the curvature of the road is calculated, the yaw degree of the vehicle may vary along the curvature. Accordingly, when the estimated trajectory of the vehicle is calculated based on the curvature of the road, the estimated yaw degree may be calculated by comparing the computed estimated trajectory with an estimated trajectory acquired using the steering angle and the vehicle speed.

Furthermore, the yaw degree of the vehicle may be calculated based on the curvature of the road at a location when the vehicle is currently located. The substantially accurate yaw degree of the vehicle may be calculated based on the yaw degree of the vehicle using, for example, a method of calculating the average value of the yaw degree of the vehicle and the current steering angle. is the yaw degree may be a value that based on map information and obtained through compensation, and thus may be considered to be a map based yaw degree.

Thereafter, of the process includes acquiring, by the processor, the bias of the yaw rate sensor by comparing the measured value of the yaw rate sensor with the map based yaw degree. FIG. 3 is an exemplary block diagram illustrating the acquisition of the bias in the method of acquiring the bias of a yaw rate sensor for a vehicle shown in FIG. 1. Referring to FIG. 3, the bias of the yaw rate sensor may be acquired based on the difference between the measured value of the yaw rate sensor and the map based yaw degree.

Specifically, the map based angular speed may be calculated by differentiating the map based yaw degree, and the bias of the yaw rate sensor may be calculated based on the difference between the map based angular speed and the measured value of the yaw rate sensor.

Furthermore, the bias of the yaw rate sensor may be acquired by averaging the differences between the map based angular speed and the measured value of the yaw rate sensor, since the map based angular speed and the measured value of the yaw rate sensor are values calculated in real time.

Moreover, FIG. 5 is an exemplary diagram illustrating the step of determining an abnormal driving behavior (e.g., rocking of the vehicle, a sharp turn, unanticipated bumps, and the like) using the method of acquiring the bias of a yaw rate sensor for a vehicle shown in FIG. 1. The process may further include calculating, by the processor, a compensation value for the yaw rate sensor by removing the bias of the yaw rate sensor from the measured value of the yaw rate sensor. The compensation value for the actually measured value of the yaw rate sensor may be calculated by substituting the bias acquired during the actual running of the vehicle.

Furthermore, the process may further include acquiring, by the processor, a filtered compensation value for the yaw rate sensor by filtering the compensation value for the yaw rate sensor using the map based yaw degree. A more accurate compensation value for the yaw rate sensor may be acquired using one of a variety of filters, including a Kalman filter and an alpha-beta filter. Finally, the compensation value for the yaw rate sensor may be used to compute the yaw degree of the vehicle.

Moreover, the process may further include storing, by the processor, the bias of the yaw rate sensor at each interval. Furthermore, the storing process may further include acquiring, by the processor, the bias of the yaw rate sensor in substantially the same interval and comparing, by the processor, the acquired bias of the yaw rate sensor with the previously stored bias of the yaw rate sensor. In addition, the process further include determining, by the processor, the abnormal behavior of the vehicle or the abnormal surface of a road (e.g., a substantially uneven surface of a road) through the comparison with the stored bias of the yaw rate sensor.

In other words, the bias of the yaw rate sensor may be calculated and stored for each speed or interval when the vehicle is running on a road, and the bias of the yaw rate sensor may be calculated again using the stored value when the vehicle is running in substantially the same interval again, thereby improving accuracy.

Further, when the vehicle is running in substantially the same interval again, the condition of the surface of the road or the driving condition of the vehicle may be estimated by comparing the stored value and the recalculated bias of the yaw rate sensor.

The method described above of acquiring the bias of a yaw rate sensor for a vehicle is capable of substantially accurately detecting the bias of the yaw rate sensor in an environment in which the yaw rate continuously varies, such as a substantially curved road, thereby computing a more accurate yaw degree. The method is also capable of improving accuracy when determining the yaw degree using the yaw rate sensor, and is capable of improving accuracy when determining the yaw degree when actively estimating or calculating the varying bias while the vehicle is running on a substantially curved road. Furthermore, the method is capable of being applied to the estimation of the bias of a gyro-rate sensor in the pitch and roll directions when map information includes information regarding the pitch and roll of a road.

Moreover, the method is capable of improving the accuracy of the calculation of the bias by profiling the gyro bias of a specific interval and applying the gyro bias when the vehicle is running in the corresponding interval again, and is capable of estimating a driving condition of the vehicle or the condition the surface of a road by profiling the gyro bias of a specific interval and analyzing the difference between the profiled bias value and the computed bias value.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of acquiring a bias of a yaw rate sensor for a vehicle, comprising:
matching, by a processor, map information based on global positioning system (GPS) information and vehicle speed information;
determining, by the processor, a curvature of a road;
calculating, by the processor, a map based yaw degree based on the curvature of the road using steering angle information and the vehicle speed information; and
acquiring, by the processor, the bias of the yaw rate sensor by comparing a measured value of the yaw rate sensor with the map based yaw degree.

2. The method of claim 1, wherein the GPS information comprises one or more of a location, a speed, and a yaw degree.

3. The method of claim 1, wherein acquiring the bias of the yaw rate sensor includes:
calculating, by the processor, a map based angular speed by differentiating the map based yaw degree; and
calculating, by the processor, the bias of the yaw rate sensor based on a difference between the map based angular speed and the measured value of the yaw rate sensor.

4. The method of claim 3, wherein acquiring the bias of the yaw rate sensor includes:
averaging, by the processor, differences between the map based angular speed and the measured value of the yaw rate sensor.

5. The method of claim 1, wherein acquiring the bias of the yaw rate sensor includes further includes:
calculating, by the processor, a compensation value for the yaw rate sensor by removing the bias of the yaw rate sensor from the measured value of the yaw rate sensor.

6. The method of claim 5, wherein calculating a compensation value for the yaw rate sensor further includes:
acquiring, by the processor, a filtered compensation value for the yaw rate sensor by filtering the compensation value for the yaw rate sensor using the map based yaw degree.

7. The method of claim 1, wherein the method further comprises:
storing, by the processor, the bias of the yaw rate sensor at a plurality of intervals.

8. The method of claim 7, wherein storing the bias of the yaw rate sensor further includes:
acquiring, by the processor, a bias of the yaw rate sensor again in a corresponding interval; and
comparing, by the processor, the acquired bias of the yaw rate sensor with the previously stored bias of the yaw rate sensor.

9. The method of claim 8, wherein the method further includes:
determining, by the processor, a driving condition of the vehicle and a condition of surface of the road through the comparison with the stored bias of the yaw rate sensor.

10. A system of acquiring a bias of a yaw rate sensor for a vehicle, comprising:
a processor configured to:
match map information based on global positioning system (GPS) information and vehicle speed information;
determine a curvature of a road;
calculate a map based yaw degree based on the curvature of the road using steering angle information and the vehicle speed information; and
acquire the bias of the yaw rate sensor by comparing a measured value of the yaw rate sensor with the map based yaw degree.

11. The system of claim 10, wherein the GPS information comprises one or more of a location, a speed, and a yaw degree.

12. The system of claim 10, wherein the processor is further configured to:
calculate a map based angular speed by differentiating the map based yaw degree; and
calculate the bias of the yaw rate sensor based on a difference between the map based angular speed and the measured value of the yaw rate sensor.

13. The system of claim 12, wherein the processor is further configured to:
average differences between the map based angular speed and the measured value of the yaw rate sensor.

14. The system of claim 10, wherein the processor is further configured to:
calculate a compensation value for the yaw rate sensor by removing the bias of the yaw rate sensor from the measured value of the yaw rate sensor.

15. The system of claim 14, wherein the processor is further configured to:
acquire a filtered compensation value for the yaw rate sensor by filtering the compensation value for the yaw rate sensor using the map based yaw degree.

16. The system of claim 10, wherein the processor is further configured to:
store the bias of the yaw rate sensor at a plurality of intervals.

17. The system of claim 16, wherein the processor is further configured to:
acquire a bias of the yaw rate sensor again in a corresponding interval; and
compare the acquired bias of the yaw rate sensor with the previously stored bias of the yaw rate sensor.

18. The system of claim 17, wherein the processor is further configured to:
determine a driving condition of the vehicle and a condition of surface of the road through the comparison with the stored bias of the yaw rate sensor.

19. A non-transitory computer readable medium containing program instructions executed by a processor or controller, the computer readable medium comprising:
program instructions that match map information based on global positioning system (GPS) information and vehicle speed information;
program instructions that determine a curvature of a road;
program instructions that calculate a map based yaw degree based on the curvature of the road using steering angle information and the vehicle speed information; and
program instructions that acquire the bias of the yaw rate sensor by comparing a measured value of the yaw rate sensor with the map based yaw degree.

20. The non-transitory computer readable medium of claim 19, further comprising:
program instructions that calculate a map based angular speed by differentiating the map based yaw degree; and
program instructions that calculate the bias of the yaw rate sensor based on a difference between the map based angular speed and the measured value of the yaw rate sensor.
